(19) United States
(12) Patent Application Publication
(10) Pub. No.: US 2003/0137431 A1
(43) Pub. Date: Jul. 24, 2003

(54) System and method for improving animal breeding efficiency

(76) Inventor: Thomas Hogan, Marietta, GA (US)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 10/056,220

(22) Filed: Jan. 24, 2002

(51) Int. Cl. A01K 1/10; G08C 19/04

(52) U.S. Cl. 340/870.11; 119/51.02

(57) ABSTRACT

An enhanced electronic identification device is attached to the ear of a female animal. The EEID identifies the animal and records internal body temperature at key times. A transponder is attached to a male animal and detects proximity of the male animal to the female animal. When an interaction event of sufficient duration occurs, the female identity and temperature information is received by the transponder and relayed to an analysis network for determining critical times, dates, and other breeding efficiency factors.

### FIELD OF THE INVENTION

The present invention relates to systems and methods for improving animal breeding techniques by using electronic measurement and communications equipment to optimize breeding practices.

### BACKGROUND

In the food animal industry, science and technology have not always evolved simultaneously. This disparity is acutely recognizable in breeding practices relating to food animal production—beef and pork, in particular.

For example, scientists have determined with great certainty the optimal breeding conditions for cattle. With scientific controls in place, the time of peak estrous of a female animal can be determined, largely by monitoring internal body conditions—such as temperature and respiration—of the female animal. Once peak estrous has been determined, the optimum window for artificial insemination of the female is 10-14 hours later. Furthermore, shifting the actual time of artificial insemination forward or backward within that narrow window significantly changes the likelihood that the female's offspring will be male or female. Female animals, because of their obvious ability to give birth to more animals, are valued much higher than their male counterparts. Because the success rate of artificial insemination effort and offspring gender play a huge role in both the short-term and long-term profitability of a food animal operation, a premium is placed on this selection-by-timing methodology.

Technology—the tools and practices used to implement scientific accepted principles such as the “selection-by-timing” principle described above—lags behind science in its ability to practically and accurately determine peak estrous in a female animal in field conditions, as opposed to the controlled environment of a laboratory or test facility.

Absent field-worthy systems for monitoring peak estrous indicators in large-scale field operations, ranchers maintain their age-old practice of relying on observation of secondary estrous indicators, such as outward physical characteristics and behavior of the animals. More specifically, females in estrous typically show secretions from their sex organs, and will typically allow male animals to mount them more often and for a longer period of time than if not in estrous. Commonly, a cowboy on horseback will patrol a ranch looking for one or both of these indicators, thereby signaling that the female is in estrous and indicating an appropriate time for artificial insemination.

Unfortunately, these secretions may last for days, and only indicate that the female is in estrous, without any indication as to peak estrous. Depending on when the cowboy makes an observation and the time the artificial insemination is accomplished, peak estrous may have long since passed, or may not have yet occurred.

Similarly, observing a female animal willing to accept a prolonged mount from a male animal only indicates a likelihood that the female is in estrous . . . without any indication as to peak. Again, the relatively narrow window for optimal artificial insemination could be missed, even if the cowboy's observations are correct and insemination is accomplished quickly.

In summary, basing the timing of artificial insemination on the physical symptoms of estrous is inherently inaccurate because peak estrous cannot be determined simply by observation and analysis of these physical symptoms.

An example of a sophisticated system limited by the inaccuracies of physical symptom evaluation can be found in U.S. Pat. No. 4,503,808 to McAlister (“the '808 patent”). The '808 patent teaches a system for electronically monitoring, recording and reporting the occurrence and duration of mounts of a female animal by a male animal. This system is designed to discriminate between short-duration mounts (indicating that the female is not in estrous), and longer-duration mounts, which tend to indicate that the female is in estrous. For all its electronic data collection and data discrimination capabilities, the best that the system disclosed in the '808 patent can hope for is an accurate determination that the female animal is actually in estrous. The disclosed system cannot detect—and does not purport to detect—the narrow window of peak estrous within the much longer estrous period.

Accordingly, there is a need for a system and method for accurately determining when a female animal is in peak estrous.

There is a further need for such a system and method by which peak estrous detection can be made automatically.

A still further need exists for such a system and method that can be successfully implemented on a large scale in a typical ranch or open range environment.

### SUMMARY OF THE INVENTION

A system for improving animal breeding efficiency includes an enhanced electronic identification device (“EEID”) that is fixedly attached to a female animal. The EEID identifies the female animal, determines the internal body temperature of the animal, then links the identity of the female animal with its internal body temperature. The EEID then transmits the linked identity and temperature as a data signal.

A transponder is attached to a male animal. When the male animal mounts the female animal, the transponder receives the data signal and further links the data signal with the identity of the male animal. A database, interconnected to the transponder, generates an interaction dataset for transmission to a PDA. The PDA receives the interaction dataset from the transponder and forwards it to a computer. The computer communicates, via a communications network, information relating to the interaction dataset with at least one other computer, and aggregated interaction datasets are analyzed to determining breeding efficiency factors based on the interaction datasets.

### BRIEF DESCRIPTION OF THE DRAWINGS

FIG. 1 depicts a system-level block diagram illustrating the primary components utilized in a representative embodiment of the present invention.

FIG. 2 depicts a system-level block diagram illustrating the primary components utilized in another exemplary embodiment of the present invention.

FIG. 3 depicts a system-level block diagram illustrating the primary components utilized in yet another exemplary embodiment of the present invention.

### DETAILED DESCRIPTION OF THE INVENTION

As previously indicated, the principles and methods of the present invention will find equal applicability to any animal breeding operation desiring to improve breeding efficiencies. For the purpose of illustration only, the example of a cattle rancher and his beef operation will be used.

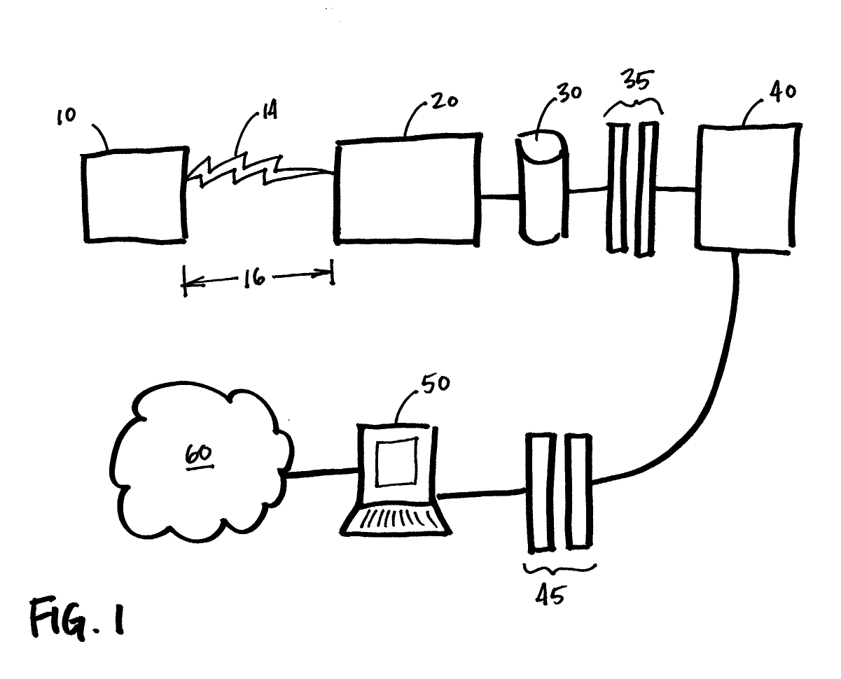

FIG. 1 depicts a system-level block diagram illustrating the primary components utilized in one embodiment of the present invention, and the interrelation of those components to one another. The depicted embodiment of the system comprises, generally, an Enhanced Electronic Identification Device (“EEID”) 10, a transceiver 20, a database 30, a personal digital assistant (“PDA”) 40, and a computer 50.

The EEID 10 is, in some respects, very similar to Radio Frequency Identification Devices (“RFIDs”) fully described in other, pending and allowed patent applications to this inventor, such as U.S. patent application Ser. No. 09/832,385, filed Apr. 11, 2001, entitled “Tamper-proof Animal Identification Tag,” and U.S. patent application Ser. No. 09/477,262, filed Jan. 3, 2001, entitled “A System and Method for Automatically Recording Animal Injection Information,” the teachings of which are specifically incorporated by reference. Simply put, the EEID 10 carries the functionality of well-known RFIDs, in that it is programmed with a unique code, such as a Universal Livestock Code (“ULC”) that positively identifies the animal to which it is attached. Furthermore, the typical RFID transmits that ULC electronically to a receiver or some other receiving device, either periodically (in the case of an “active” RFID), or in response to a triggering signal, as in the case of a “passive” RFID. This functionality is well known to those skilled in the art of Radio Frequency identification devices, in general, and animal identification devices, in particular.

The EEID 10 combines with conventional RFID capabilities the ability to monitor the body temperature of the animal to which it is attached. Just as body temperature readings of small children can be taken by the ear, the ear is also a very accurate indicator of body temperature in animals such as cattle, hogs, sheep, etc, because of the large volume of blood circulation through the ears. When the EEID 10 is attached to the ear of an animal, such as by a conventional “punching” technique, a proximal connection is made between the EEID 10 and the ear that allows the temperature of the animal to be automatically monitored without the need for additional equipment.

The transceiver 20 is attached to a male animal. Numerous well-known configurations for attaching such a transceiver 20 to a male animal have been suggested and implemented, with any variety of such configurations being entirely sufficient. An important aspect of the attachment, though, is that it be secure enough to withstand the abuse that can be expected in the field, yet easy enough to remove so that the rancher can replace, re-program or repair it. In an embodiment of the present invention, one of the functionalities of the transceiver 20 is to receive from the EEID 10 a data signal 14. Other functionalities of the transceiver 20 will be later described.

The data signal 14 contains the unique identification code (the ULC) and the body temperature of the animal to which it is attached. The data signal 14 is transmitted from the EEID 10 when the transceiver 20 comes within a certain predetermined proximal range 16 with it. Many complex systems exist that will allow determination as to when the range 16 predetermination has been met, but the simplest may be calibration of the transmission and receiving capabilities of the EEID 10 and the transceiver 20 such that communication of a data signal 14 between the two will not be effective at ranges greater than range 16.

The triggering event that triggers transmission of data signal 14 from the EEID 10 is also subject to many well-known and equally acceptable variations. For example, if the EEID 10 is of the passive variety, it will only transmit the data signal 14 when a stimulus signal is received. If the EEID 10 is an active device, its data signal 14 will be transmitted continuously, but will only be detected by the transceiver 20 when the transceiver 20 is within range 16 of the EEID 10.

As previously discussed, the peak estrous of a female animal is the key point from which calculations for artificial insemination are calculated. To most accurately determine when a female animal is in peak estrous, it is desirable to combine several indicators. One indicator is the outward condition of the female animal's genitalia. Observant male animals will detect that a female animal is in heat, and attempt to mount her (each mount known as an “interaction event”). Unfortunately, the outward appearance of a female animal in heat begins well before peak estrous and continues well after peak estrous has passed. A male animal is equally likely to mount the female at any point during the period of estrous. Furthermore, male animals occasionally attempt to mount female animals who exhibit no signs of estrous, further diminishing the value of the observation of a male animal mounting a female in determination of peak estrous in the female. Once a male animal mounts a female, though, the duration of the mount becomes a more accurate indicator that the female is actually in estrous.

The determination that an animal is in peak estrous is accomplished by monitoring the temperature of the female animal at points during extended mounts by the male animal, as it is well known that a female animal's temperature peaks during peak estrous. More particularly, when the transceiver 20 is within range 16 of the EEID 10 for a sufficient, predetermined period of time (indicating that the mount is not a false mount), the data signal 14 transmitted from the EEID 10 to the transceiver 20 will contain both the ULC for the animal, as well as the temperature of the animal, measured at predetermined intervals. The combination of these two factors—the extended duration mount with the temperature readings of the female animal—will allow determination of peak estrous with unprecedented accuracy.

Once the data signal 14 has been received by the transponder 20, the data conveyed by the data signal 14 from the EEID 10 to the transceiver 20 is stored in a database 30 as an interaction dataset. In an embodiment of the present invention, the database is contiguous to the transceiver 20 attached to the male animal. Because the determination of peak estrous in the female animal requires frequent monitoring (and will be downloaded regularly), the size of the database 30 need not be large. Further, the database 30 optimally employs a mechanism for relaying the data received from the data signal 14 to an operator.

One embodiment of a satisfactory relaying configuration, depicted in FIG. 1, relies on an interface 35 between the database 30 and a portable data collection device such as a personal digital assistant (“PDA”) 40. The exact nature of the interface is not critical, but could be a conventional serial or other hard-wired connection, effected with a male connector on one side of the interface and a mating female connector on the other.

The PDA 40 then, after receiving a download of the data from the database 30 via interface 35, is equipped to transfer the data to a computer 50 via interface 45. For the purpose of simplistic illustration, the PDA 40 is depicted as having two interface connections, 35 and 45. However, it will be understood and appreciated that one, single interface connection may accomplish both interconnection to the database 30 and the computer 50.

The depiction of a computer 50 is representative of a data accumulation mechanism. Such a data accumulation mechanism may be an ordinary computer 50 such as a PC, or it may be no more than a modem connection to a data accumulator such as a computer 50 or a network of computers 50 at a different location. Ultimately, the data accumulator—be it a computer 50 or otherwise—is linked to the internet for sharing, storage, analysis, calculation and distribution of breeding efficiency factors, which include data such as optimal artificial insemination times and dates, sire numbers in a natural service situation, etc. Other breeding efficiency factors might be, for example, information allowing individual animals to be categorized as “Very Likely to Breed”, “Likely to Breed”, “Marginal Breeder”, “Unlikely to Breed”, or “Very Unlikely to Breed”. Identification of breeding efficiency factors in individual food animals is very desirable. As information is collected regarding the breeding characteristics of individual animals, it can then be evaluated with regard to particular breeds or herds . . . with comparisons and statistical databases allowing evaluation of similar animals in particular geographic regions. For example, an Argentine rancher may only want to compare the factors derived from his animals to animals bred in similar climates . . . other regions of South America or, perhaps, Texas . . . he may not be interested in comparisons to animals bred in drastically different environments.

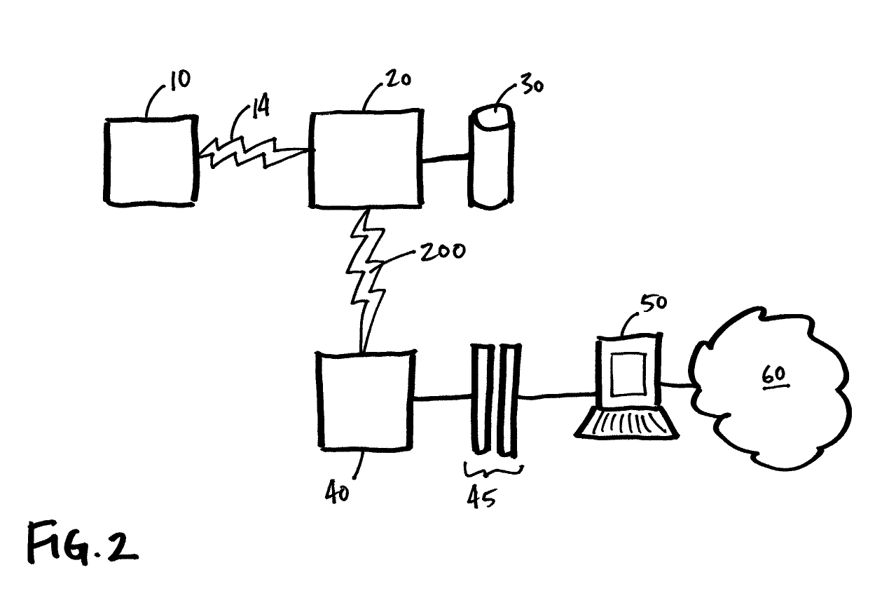

FIG. 2 depicts another embodiment of the present invention. The basic functionality of the system of FIG. 2 is the same as that depicted in FIG. 1, with the exception of the communicative interconnection between the database 30 and the PDA 40.

More specifically, the embodiment depicted in FIG. 2 does not provide for a serial or other wired connection between the database 30 and the PDA 40. Instead, the transceiver 20 is functional to package data stored in the database 30 and transmit via wireless link 200 to the PDA 40. The PDA 40 is functional to receive the data transmission from the transceiver.

A wide variety of communications modes are available and suitable to effect the transmission of data via wireless link 200. Because in this embodiment, the need for long-distance transmission is small, the range of the wireless link 200 can be correspondingly short. This performance characteristic may be accomplished by a relatively low-power RF link of the well known type suitable for transmission of data-rich communication.

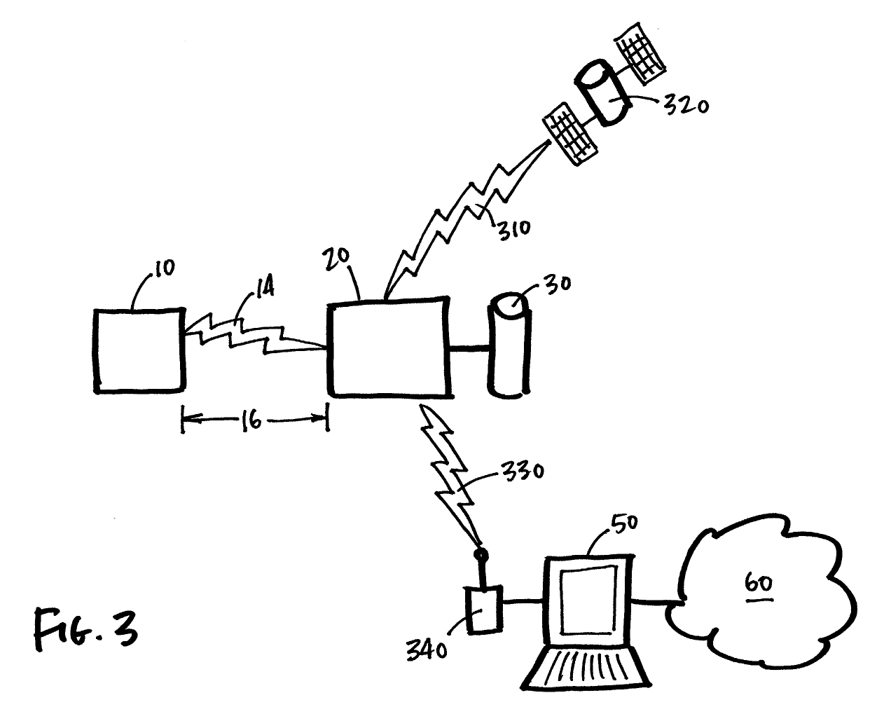

FIG. 3 depicts yet another embodiment of the present invention, with an added functionality. The transceiver 20 of FIG. 3 carries the additional capability of determining its pin-point geographic location by transmission and receipt of a location signal 310 to and from a Global Positioning System (“GPS”) satellite system 320. As the transceiver 20 comes into range 16 of the EEID 10, it simultaneously transmits a location inquiry to the overhead GPS satellite 320. The GPS satellite returns to the transceiver 20 position coordinates, which are linked to the data contained in the data signal 14 and stored in the database 30 until ready for transmission from the transceiver 20 in the form of a data download 330.

Also depicted in this embodiment (and equally adaptable to other embodiments) is the means by which the PDA 40 described with respect to other embodiments can be eliminated. Specifically, a receiver 340 can be functionally interconnected to the computer 50 for receiving, directly, transmissions such as the data download 330, as sent by the transceiver 20. The versatility of this configuration is evident, when considering that the computer 50 could be of the portable or laptop variety, and both the computer 50 and receiver 340 could be easily carried in a truck or other vehicle about the vast expanses of a typical ranch to collect the data downloads 330 from various transceivers 20.

Although various embodiments of the present invention have been disclosed in detail above, it will be apparent that various modifications thereto can be readily made. These and other such modifications are all intended to fall within the scope of the present invention as defined by the appended claims.

1. A method for improving animal breeding efficiency, comprising the steps of:
a. attaching an EEID to a female animal;
b. attaching a transponder to a male animal;
c. recording an interaction event between a male animal and a female animal;
d. determining the internal body temperature of the female animal at a time proximal to the interaction event;
e. linking the interaction event recording with the internal temperature determination to form a first interaction dataset;
f. aggregating the first interaction dataset with a plurality of other interaction datasets in a database; and
g. analyzing the interaction datasets to determine a breeding efficiency factor.

2. The method of claim 1 wherein a temperature sensor in the EEID determines the internal body temperature of the female animal.

3. The method of claim 1 comprising the further step of transmitting the first interaction dataset to an aggregator for aggregation with the plurality of other interaction datasets in a database.

4. The method of claim 3, wherein the step of transmitting is accomplished by a wireless link.

5. A system for improving animal breeding efficiency, comprising:
(a) an EEID, attached to a female animal, for identifying the female animal, for determining the internal body temperature of the female animal, for linking the identity of the female animal with the internal body temperature of the female animal, and for transmitting the linked identity and temperature of the female animal as a data signal; and
(b) a transponder, attached to a male animal, for receiving the data signal, linking the data signal with the identity of the male animal, and generating a interaction dataset for transmission to a first computer.

6. The system of claim 5, further comprising a network of computers, communicatively interconnected to the first computer, for accumulating and analyzing a plurality of interaction datasets.

7. The system of claim 5, further comprising a PDA for receiving the interaction dataset from the transponder, the PDA being further capable to store the interaction dataset until the interaction dataset is downloaded to the first computer at a subsequent time.

8. The system of claim 6, wherein the plurality of interaction datasets is analyzed to develop breeding efficiency factors.

9. The system of claim 5, wherein the transponder is functional to obtain a GPS coordinate proximal to formulation of the interaction dataset, which GPS coordinate is incorporated within the interaction dataset.

10. The system of claim 7, wherein the PDA receives the interaction dataset from the transponder by a wireless link.

11. A system for improving animal breeding efficiency, comprising:
(a) an EEID, attached to a female animal, for identifying the female animal, for determining the internal body temperature of the female animal, for linking the identity of the female animal with the internal body temperature of the female animal, and for transmitting the linked identity and temperature of the female animal as a data signal;
(b) a transponder, attached to a male animal, for receiving the data signal, linking the data signal with the identity of the male animal, and generating a interaction dataset for transmission;
(c) a PDA for receiving the interaction dataset from the transponder;
(d) a computer for receiving the interaction dataset from the PDA and communicating, via a communications network, information relating to the interaction dataset with at least one other computer; and
(e) an aggregator, for determining breeding efficiency factors based on the interaction datasets.
